(19) United States
(12) Patent Application Publication
(10) Pub. No.: US 2008/0041203 A1
(43) Pub. Date: Feb. 21, 2008

(54) Cutting Device with a Drive for Adjusting Cutting Edges

(76) Inventors: Martinus Regterschot, Wapenveld (NL); Heinz Gutknecht, Epe (NL); Antonie Slots, Heeten (NL)

Correspondence Address: LADAS & PARRY, 26 WEST 61ST STREET, NEW YORK, NY, 10023, US

(21) Appl. No.: 11/791,127

(22) PCT Filed: Dec. 13, 2005
(86) PCT No.: PCT/NL05/00852

§ 371 Date: May 18, 2007

(30) Foreign Application Priority Data
Dec. 13, 2004 (NL) 1027733

(51) Int. Cl. B26D 7/26

(52) U.S. Cl. 83/13; 700/159; 83/553; 83/74

(57) ABSTRACT

The invention relates to a cutting device (1) for cutting strips from a web of material, particularly a web of unvulcanised rubber, more particularly cord reinforced, unvulcanised rubber, comprising a first element having a first cutting edge (14), a second element having a second cutting edge (15), wherein the first and second cutting edge are movable past each other for in cooperation cutting the strips, and a drive (12, 121) for mutually laterally adaptably adjusting the cutting edges with respect to each other.

The invention relates to a cutting device, particularly a cutting device for cutting webs of unvulcanised rubber provided with reinforcement cords.

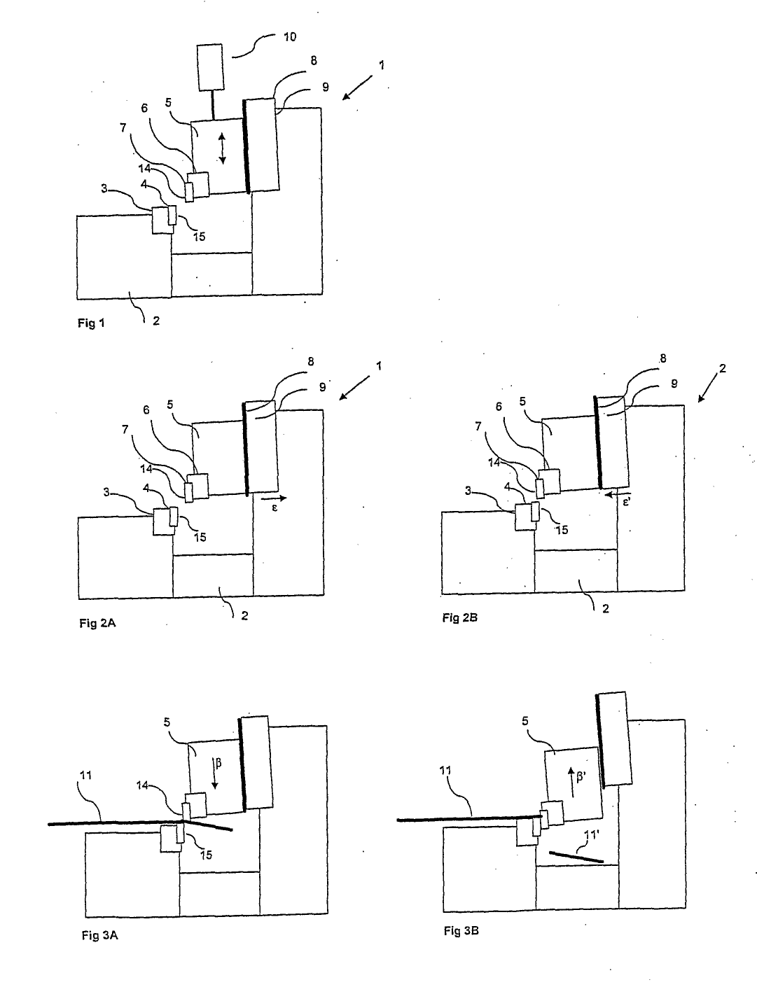

Such cutting devices are known. For instance EP-A2-1.306.174 in FIG. 1 shows a cutting device for webs of cord reinforced unvulcanised rubber for making belt layers for car tyres. The cutting devices used in such an arrangement are usually provided with a blade and a cutting beam or second blade, as shown in FIG. 2 of said document. Usually a lower blade or lower beam is stationary and an upper blade moves vertically up and down in order to make the cuts. In general such cutting devices are therefore provided with two cutting edges, which during cutting move alongside each other. Said known cutting devices usually have a so-called negative cutting play or clearance, that means that the cutting edges overlap prior to cutting. As at least one of the blades is usually curved then, that means convex with respect to the other blade or beam, the cutting edges are urged against each other during cutting, as a result of which a proper cut is obtained. The wear, however, is very high as a result, and the entire device is subjected to large forces during cutting.

In EP-A2-1.396.174 it is attempted to improve this by a specially developed resilient blade.

From U.S. Pat. No. 5,423,240 a cutting device for rubber material is known wherein a circular blade is urged against a lower beam by means of spring force.

In addition, EP-1.034.869 describes a cutting device for metal plate, particularly having an L-shape. In the returning stroke, that means when lifting an upper blade, the space between a lower blade and the upper blade is increased. When cutting metal plate a space between the blades is necessary during cutting, that means during the downward motion of the upper blade. Moreover when lifting, the upper blade wears as it scrapes past the cut metal plate.

Wear of the blades and the transfer of the forces on the device, however, remain to be a problem.

In addition cutting rubber material has its own specific problems.

It is among others an object of the invention to improve on that.

To that end the invention provides a cutting device for cutting strips from a web of material, particularly a web of unvulcanised rubber, more particularly cord reinforced, unvulcanised rubber, comprising a first element having a first cutting edge, a second element having a second cutting edge, wherein the first and second cutting edge are movable past or along each other for in cooperation cutting the strips, and a drive for mutually laterally adaptably adjusting the cutting edges with respect to each other.

A drive rendering the elements mutually adaptably adjustable, makes it possible to adjust the forces that the elements exert on each other during cutting. As a result the wear of the blades can be reduced, the maximum force can be reduced, and during the entire cutting path (the entire cutting cycle) the optimum force can be set. Usually the adjustments necessary are very small, and lead to a very slight lateral adjustment of both elements, often in the order of microns or smaller. Especially in machines for manufacturing tyres, wherein first of all the elements are large, and the cutting forces due to the materials used are large, but most of all the requirements to the cutting accuracy and reproducibility are great, the adjustability may result in strongly reducing wear, which in turn leads to a more accurate cut and higher reproducibility.

Particularly when cutting rubber material, the mutual distance of the blades, that means the cutting slit, is of importance. In order to be able to cut rubber material it is namely preferred that in the downward motion, that means the actual cutting motion, the cutting slit is negative. That means, considered from above, the upper blade and the lower blade overlap each other. This as opposed to cutting devices for cutting metal plate, particularly steel plate, in which cases there needs to be space between the blades.

In this case the drive is an element that can be switched on and off, and is controllable. An example of such a drive is a hydraulic or pneumatic cylinder. Other examples are electric and/or mechanical drives.

In one embodiment of the cutting device according to the invention the drive is adapted for during the cutting cycle mutually laterally adaptably adjusting the cutting edges with respect to each other.

In a further or alternative embodiment thereof the drive is adapted for during said moving past each other mutually laterally adaptably adjusting the cutting edges with respect to each other.

By making said active drive possible even during the cutting process itself, the opportunity is given of better controlling the cutting process. Said solution is contrary to the route taken up until now, in which it was attempted to design the elements and the cutting device increasingly rigid and heavy, and rule out every possibility of play or clearance.

In one embodiment both elements are controllably mutually laterally adjustable.

In one embodiment the drive is adapted for with variably adjustable transverse force pressing both cutting edges against each other, particularly with variably adjustable transverse force during cutting. In one embodiment thereof the cutting edges move past each other in a cutting stroke and a returning stroke, and the drive is adapted for exerting the transverse force during the cutting stroke, and exerting no transverse force during the returning stroke. Alternatively instead of the force, the location or displacement can also be determined by means of sensors and the lateral adjustment can take place either according to a pre-set track, or based on values measured by means of the sensors.

In one embodiment of the cutting device according to the invention the first element and the second element together form a guillotine wherein the first element is an upper blade and the second element a lower blade.

In one embodiment thereof the drive is adapted for laterally adjusting the lower blade with respect to the upper blade.

In an alternative embodiment thereof the drive is adapted for adjusting the upper blade with respect to the lower blade.

In one embodiment of the cutting device according to the invention the drive comprises one or more hydraulic or pneumatic cylinders for laterally adjusting the elements with respect to each other.

In one embodiment of the cutting device according to the invention the first or second element comprises a long blade.

In one embodiment of the cutting device according to the invention the first and second element together form a pair of scissors.

When the first and second elements have been designed in such a way the mutual lateral adjustment is of great importance for the functioning.

In one embodiment of the cutting device according to the invention the first and second elements have a first and second end and the drive comprises at least two drive elements, having a first drive element at a first end of an element and a second drive element at the other end. In one embodiment even one or more further drive elements have been arranged between these two drive elements, in which way the curvature of an element is adjustable.

In one embodiment of the cutting device according to the invention it further comprises a control device for controlling the drive. In a further embodiment sensors are even provided for reading the force exerted by the elements on each other, or sensors for the location or displacement, or other sensors from the readings of which said force can be derived. In a further embodiment the sensors are operationally connected to the control device. Based on the values of the sensors the control device is able to adjust the mutual lateral position of the elements with respect to each other during the cutting cycle to a pre-determined value, or even a pre-set curve. For that purpose the control device may comprise a computer provided with software for reading measurement values from the sensors, comparing said measurement values with a value stored in a memory, and giving adjustment values to the drive.

Such a cutting device is not as rigid and inflexible as was common up until now, but has elements or cutting elements of which the mutual lateral position and even the mutual shape is dynamically adjustable.

In one embodiment of the cutting device according to the invention both blades are mutually adjustable in order to set a negative cutting clearance when cutting.

In one embodiment of the cutting device according to the invention the first and second element are mutually adjustable which adjustment can be switched on and off.

In one embodiment of the cutting device according to the invention it is adapted for cutting breaker plies for vehicle tyres.

In one embodiment of the cutting device according to the invention it is adapted for cutting other components for building vehicle tyres.

The invention further relates to a cutting device for cutting strips from a web of material, particularly a web of unvulcanised rubber, more particularly cord reinforced unvulcanised rubber, comprising a first cutting element and a second cutting element for in cooperation cutting the strips, and a drive for during the movement past each other of the cutting edges adjusting the lateral force of the cutting edges with respect to each other.

In one embodiment of said cutting device the first cutting element comprises a first cutting edge and the second cutting element comprises a second cutting edge, and the first and second cutting edge are movable past each other for in cooperation cutting the strips.

The invention further regards a cutting device for cutting strips from a web of material, particularly a web of unvulcanised rubber, more particularly cord reinforced unvulcanised rubber, comprising a first cutting element and a second cutting element for in cooperation cutting the strips, sensors for detecting the lateral force the cutting elements exert on each other, and a drive, operationally connected to the sensors, for according to pre-set values adjusting the force the cutting elements exert on each other in lateral direction.

In one embodiment of said cutting device the first cutting element comprises a first cutting edge and the second cutting element comprises a second cutting edge, and the first and second cutting edge are movable past each other for in cooperation cutting the strips.

The invention further relates to a method for cutting strips from a web of material, particularly a web of unvulcanised rubber, more particularly cord reinforced unvulcanised rubber, by means of a cutting device provided with a lower blade and an upper blade, wherein the lower blade and the upper blade during cutting are brought into a mutually negative cutting clearance with respect to each other and at the returning stroke are brought into a mutually positive cutting clearance.

The invention further relates to a cutting device comprising a first cutting member extending in a longitudinal direction, a second cutting member extending substantially parallel to the first cutting member, which cutting members are moveable past each other substantially along a cutting plane, a first actuator at a first end of a cutting member for exerting an adjustable force during cutting, having a component transverse to the cutting plane and a second actuator at a second end of a cutting member opposite the first end for exerting an adjustable force during cutting having a component transverse to the cutting plane.

In one embodiment thereof it further comprises a control device for controlling the force of the first and second actuator.

In a further or alternative embodiment the control device is adapted for adjusting the force exerted by the first actuator and the force exerted by the second actuator independent from each other.

In a further or alternative embodiment the cutting device is further provided with a measuring device for measuring the force during cutting which is operationally connected to the control device.

In one embodiment the control device is adapted for comparing a force as determined by the measuring device and a pre-set force, and on the basis of the comparison adjusting the force exerted by the first and/or second actuator, preferably the control device is adapted for during cutting comparing a force as determined by the measuring device and a set force and adjusting the force exerted by the first and/or second actuator.

The invention further relates to a control device intended and suitable for a cutting device as described in this document.

In addition the invention relates to computer software comprising software instructions which, once operative in a computer device, will let it function as control device as described in this document.

The invention further relates to a cutting device for cutting strips from a web of unvulcanised rubber, more particularly cord reinforced unvulcanised rubber, comprising a first element having a first cutting edge, a second element having a second cutting edge, wherein the first and second cutting edge are movable past each other substantially in a cutting plane for in cooperation cutting the strips, and a drive which engages onto at least one of either the first or the second element for during cutting moving the cutting edges with respect to each other out of the cutting plane.

By rendering an adjustment or movement possible of the elements, for instance a lower blade, a lower beam or upper blade with respect to each other out of the cutting plane, particularly with a lateral component, during carrying out a cutting motion, it proved possible to accurately control an exerted cutting force during cutting. As a result the wear of the blades can be limited. Moreover a more accurate cut proved possible.

Alternatively the cutting device is provided with a drive for adapting the shape of at least one of the cutting planes during cutting.

A simple way of realising the invention is by means of hydraulic cylinders that engage onto the elements, such as blades, and exert a force with a component transverse to the cutting plane. By measuring the hydraulic pressure and entering said measured pressure or pressures into a control device, and subsequently enabling said control device to adjust the pressure, preferably for each cylinder individually, and during carrying out the cutting motion, it has proved possible to accurately adjust the cutting force during cutting.

In addition, readers, such as (laser) position meters, strain gauge, or the like, may be provided for measuring the position or deformation of the cutting edges. By entering said measurement values into the control device the control device is able by means of the drive, or the cylinders, adjust the shape of the cutting edges during cutting.

The embodiments described above can be combined.

The invention will be elucidated on the basis of a number of exemplary embodiments shown in the attached drawings, in which:

FIG. 1 shows a side view in cross-section of a cutting device according to the state of the art;

FIG. 2A shows a side view in cross-section of a cutting device according to the state of the art;

FIG. 2B shows a side view in cross-section of a cutting device according to the state of the art;

FIG. 3A shows a side view in cross-section of a cutting device according to the state of the art;

FIG. 3B shows a side view in cross-section of a cutting device according to the state of the art;

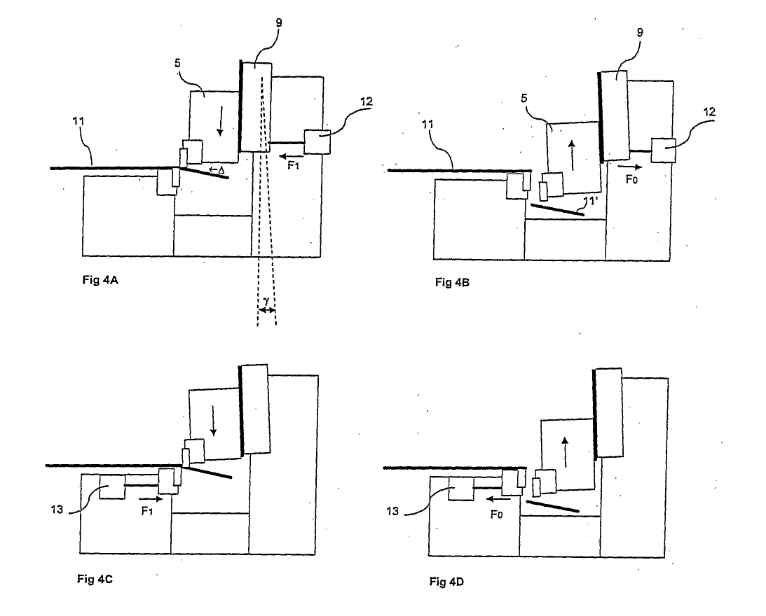

FIG. 4A shows a side view in cross-section of a cutting device according to the invention;

FIG. 4B shows a side view in cross-section of a cutting device according to the invention;

FIG. 4C shows a side view in cross-section of an alternative embodiment of a cutting device according to the invention;

FIG. 4D shows a side view in cross-section of an alternative embodiment of a cutting device according to the invention;

FIG. 5 shows a front view of a cutting device according to the state of the art;

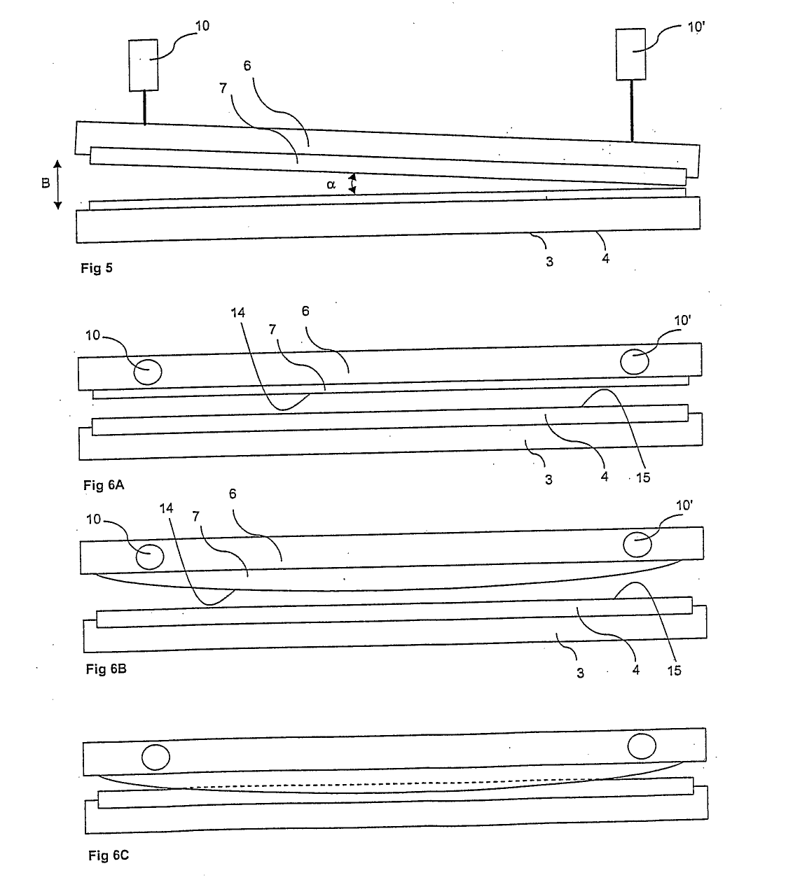

FIGS. 6A-6C show top views of a cutting device according to the state of the art;

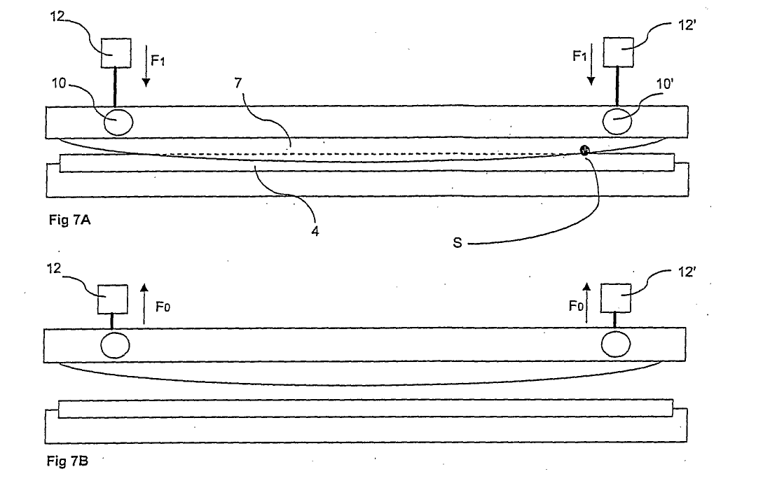

FIGS. 7A, 7B show top views of a cutting device according to the invention;

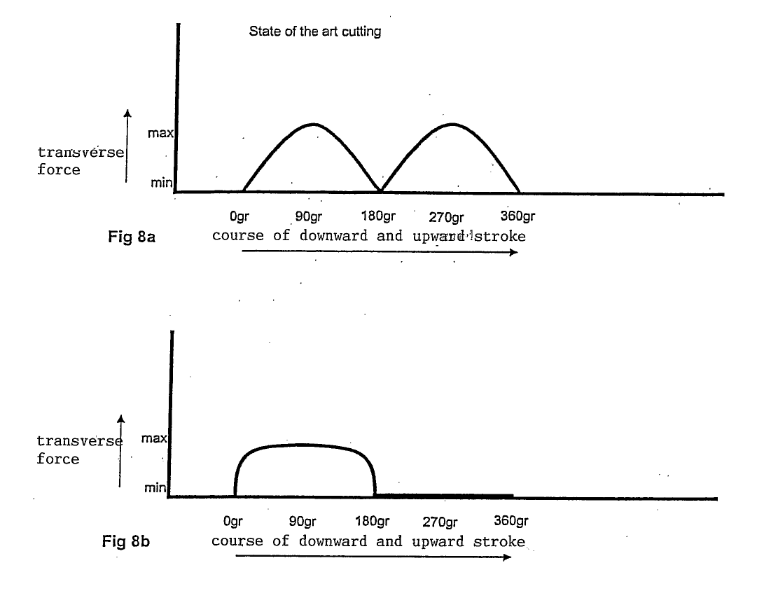

FIG. 8A shows a graph showing the forces on the blades of a cutting device according to the state of the art during the cutting process; and

FIG. 8B shows a graph showing the forces on the blades of a cutting device according to the invention during the cutting process.

FIG. 1 shows a side view in cross-section of a cutting device 1 according to the state of the art. Said cutting device 1 has a frame 2 on which a lower blade beam 3 has been mounted in which a lower blade 4 is held. The cutting device 1 is further provided with an upper frame 5 in which an upper blade beam 6 has been mounted provided with an upper blade 7. Furthermore mounted to the frame 2 is a guide block 9 provided with a guide 8 to which the upper frame 5 is movably mounted. The cutting device 1 is furthermore provided with means 10 for moving the upper frame up and down with respect to the frame. In the embodiment shown the cutting device 1 is for that purpose provided with hydraulic cylinders 10 for realising the vertical motion of the upper frame 5 with respect to the frame 2. The lower blade beam 3 and the lower blade are fixedly mounted to the frame.

In FIGS. 2A and 2B again a cross-section of a cutting device can be seen in which the settings of the cutting clearance have been indicated. In FIG. 2A the cutting device 1 is shown wherein the lower blade 4 and the upper blade have a positive cutting clearance with respect to each other. The cutting edge 15 of lower blade 4 and the cutting edge 14 of upper blade 7 are spaced apart. The positive cutting clearance means that the blades 4, 7 are spaced apart such that they are able to move past each other without touching each other.

In FIG. 2B an arrangement can be seen in which the lower blade 4 and the upper blade 7 have a negative cutting clearance with respect to each other. With a negative cutting clearance over the full length of the blades, the blades cannot move past each other.

FIG. 3 again shows the side view of FIGS. 1 and 2A, 2B wherein the cutting cycle is shown for the known cutting device of FIGS. 2A and 2B. FIG. 3A shows the downward stroke in which the cutting motion, that means the cutting stroke, takes place. In that case the upper frame 5 moves vertically downward in order to cut the unvulcanised rubber 11 provided with reinforced cords. FIG. 3B shows the cutting device after the cutting stroke in a so-called upward stroke wherein the upper frame 5 moves upward again. A strip 11′ has been cut off from a web of material 11.

FIGS. 4A-D show the cutting device according to the invention in two embodiments. In FIGS. 4A and 4B the cutting device is shown provided with a drive for mutually laterally adaptably adjusting the cutting edges with respect to each other. In the embodiment as shown in FIG. 4A the cutting device 1 is provided with a hydraulic cylinder 12 that has the guide block 9 and therefore the upper frame 5 as well, tilt over an angle γ, indicated in the figure. As a result the upper blade 7 moves in lateral direction and the blades 4, 7 move towards each other with their respective cutting edges 14, 15. During the downward or cutting stroke the blades are therefore pressed against each other with their cutting edges 14, 15 with an adjustable force.

In FIG. 4B it can be seen that the hydraulic cylinder 12 in the returning upward or clearance stroke exerts an opposite force as a result of which a space is realised between the lower blade 4 and upper blade 7. As a result the cutting edges 14, 15 during said upward motion, in which no cutting action is carried out, do contact each other and the blades 4, 7 do not wear out.

In FIGS. 4C and 4D an alternative embodiment of the cutting device according to the invention is shown, wherein a drive 13, in this case a hydraulic cylinder 13, exerts a force on the lower blade beam 3 in lateral direction in order to urge the lower blade 4 with its cutting edge 15 against the cutting edge 14 of the upper blade 7, during carrying out the cutting motion, the downward cutting stroke.

In FIG. 4D the hydraulic cylinder exerts an opposite force on the lower blade beam 3 as a result of which a space is created between the lower blade and the upper blade 7 during the upward or clearance stroke.

FIG. 5 shows a front view of the blades in the blade holders of a cutting device. It is clearly shown here that in case of a cutting device 1 according to the invention, preferably both blades 4, 7 are at an angle α to each other. When cutting, the blades therefore actually make a scissoring motion, indicated by arrow B. Both cylinders 10 and 10′ move the upper blade here in vertical direction for the cutting motion.

FIGS. 6A, 6B and 6C show a top view of a cutting device according to the state of the art. In FIG. 6A the blades are adjusted with a so-called positive cutting clearance, that means that there is space between the cutting edges of the blades.

With blades for cutting for instance unvulcanised rubber material provided with reinforcement cords such as steel cord, Twaron®, polyester yarn or rayon yarn, the upper blade will usually be pre-biassed with a bent curve, as indicated in FIG. 6B.

In FIG. 6C a cutting device is shown wherein the upper blade is pre-biassed according to the bent curve of FIG. 6B, but wherein moreover the blades furthermore have a negative cutting clearance, that means that there is a negative space between the blades, that means that considered from above the blades overlap each other. During cutting both blades are therefore urged against each other most forcefully.

FIGS. 7A and 7B show a top view of blades in a cutting device 1 according to the invention. The blades 4 and 7 are adjusted here with a negative cutting clearance and moreover pre-biassed according to a bent curve. In addition to the hydraulic cylinders 10 and 10′ for having the cutting motion of the blades carried out, the cutting device is moreover provided with hydraulic cylinders 12 and 12′ at both ends of the upper blade 7 for exerting a laterally oriented force on in this case blade 7. In this figure the intersection S is also indicated, that means the point where a cutting treatment actually takes place during the downward motion. As the upper blade 7, as has already been explained in FIG. 5 above, carries out a scissoring motion with respect to the lower blade 4 as indicated in FIG. 5 with arrow B, the intersection S will during the downward motion of the upper blade move to the left with respect to the lower blade.

In the cutting motion, the downward stroke, both hydraulic cylinders 12, 12′ exert a force F to the size of F1 in lateral direction on the upper guide block 9, particularly its lower side, as has also been indicated in FIGS. 4A and 4B. In FIG. 7B the upward or clearance stroke is shown wherein the hydraulic cylinders 12 and 12′ effectively exert no force in lateral direction as a result of which the upper blade 7 with respect to the lower blade 4 gets a so-called positive cutting clearance, as a result of which the blades during the upward or clearance stroke no longer move past each other. In this way the mutual force of both blades is almost zero and no wear of the blades will occur during the upward motion.

It is even possible to let the force exerted by the cylinders be unequal, or even not to have the cylinders operate synchronously. As a result the cutting force can be adjusted to the situation at hand. When for instance the actual force or position of the blades is measured, by controlling the force the cutting force can become as close as possible to a pre-set value.

Furthermore several drive means can be present, for instance to give one of the blades a curvature which during cutting is adjustable and may even able to change during cutting.

It is furthermore possible to adjust the mutual angle of the cutting edges during cutting.

An illustration of an effect of the invention is shown in FIGS. 8A and 8B. FIG. 8A shows a graph showing the transverse force active on two blade members in a known cutting device. It can be seen that the forces during the downward stroke (the actual cutting) and the upward stroke are almost equal. This is a result of the negative cutting clearance that has been set for achieving a proper cutting result, especially in case of cord reinforced unvulcanised rubber. It can furthermore be seen that the cutting force is not equal during the cutting treatment. The graph has a clear maximum. As a result the cutting force will hardly be sufficient in a starting and end stage, but at a certain moment will also be too large, which will show excessive wear.

In FIG. 8B the transverse force is shown in a cutting device according to the invention. The adjustment of the blade members during the cutting cycle with respect to each other can be adjusted such that the forces occur almost as indicated. In a preferred embodiment force readers or force sensors have been provided, which are operationally connected to a control device for controlling the cutting device. During the cutting cycle the force the blades mutually exert on each other, particularly the transverse force, is measured. Based on the detected value the drives adjust the blade members laterally with respect to each other, such that the actual value (“ist wert”) corresponds with a pre-set force (“soll wert”). As a result unnecessary load is prevented, yet it is ensured that during the actual cutting the forces are large enough for making a proper cut. Moreover unnecessary wear is prevented. Alternatively the blades can be provided with location readers, piezoelectric elements, strain gauges or displacement readers, that are connected to the control device and state actually realised values.

An alternative or additional way of determining the transverse force the blades exert onto each other when the lateral displacement occurs by means of hydraulic cylinders, is from the hydraulic pressure. By means of pressure readers the force can be determined that is exerted in sideward direction on the blades. Said measurement values can be fed back to a control device which subsequently is able to adjust the hydraulic pressure in order to realise the desired force. In one embodiment wherein there are at least two hydraulic cylinders, one at the one end of the blade and a second hydraulic cylinder at the opposite end, the cylinders are controlled separately so that the blade carries out a slightly tilting motion (or the blades carry out said motion with respect to each other). That means both ends of a blade as a result move with respect to each other with a movement component transverse to the cutting plane.

It will be clear that the above description is given to illustrate the operation of preferred embodiments, and not to limit the scope of the invention. Starting from the above explanation many variations that fall within the spirit and the scope of the present invention will be evident to an expert.

1. Cutting device for cutting strips from a web of material, particularly a web of unvulcanised rubber, more particularly cord reinforced unvulcanised rubber, comprising a first cutting element and a second cutting element for in cooperation cutting the strips, sensors for detecting the lateral force the cutting elements exert on each other, and a drive, operationally connected to the sensors, for according to pre-set values adjusting the force the cutting elements exert on each other in lateral direction.

2. Cutting device according to claim 1, wherein the first cutting element comprises a first cutting edge and the second cutting element comprises a second cutting edge, and the first and second cutting edge are movable past each other for in cooperation cutting the strips.

3. Cutting device according to claim 1, wherein the drive is adapted for during said moving past each other mutually laterally adaptably adjusting the cutting edges with respect to each other.

4. Cutting device according to claim 1, wherein both elements are controllably mutually laterally adjustable.

5. Cutting device according to claim 1, wherein the drive is adapted for with variably adjustable transverse force pressing both cutting edges against each other, particularly with variably adjustable transverse force during cutting.

6. Cutting device according to claim 5, wherein the cutting edges move past each other in a cutting stroke and a returning stroke, and the drive is adapted for exerting the transverse force during the cutting stroke, and exerting no transverse force during the returning stroke.

7. Cutting device according to claim 1, wherein the first element and the second element together form a guillotine wherein the first element is an upper blade and the second element a lower blade.

8. Cutting device according to claim 7, wherein the drive is adapted for laterally adjusting the lower blade with respect to the upper blade.

9. Cutting device according to claim 7, wherein the drive is adapted for adjusting the upper blade with respect to the lower blade.

10. Cutting device according to claim 1, wherein the drive comprises one or more hydraulic or pneumatic cylinders for laterally adjusting the elements with respect to each other.

11. Cutting device according to claim 1, wherein the first or second element comprises a long blade.

12. Cutting device according to claim 1, wherein the first and second element together form a pair of scissors.

13. Cutting device according to claim 1, wherein the first and second elements have a first and second end and the drive comprises at least two drive elements, having a first drive element at a first end of an element and a second drive element at the other end.

14. Cutting device according to claim 1, further comprising a control device for controlling the drive.

15. Cutting device according to claim 1, wherein both blades are mutually adjustable in order to set a negative cutting clearance when cutting.

16. Cutting device according to claim 1, wherein the first and second element are mutually adjustable which adjustment can be switched on and off.

17. Cutting device according to claim 1, adapted for cutting breaker plies.

18. Cutting device according to claim 1, adapted for cutting other components for building vehicle tyres.

19. Cutting device according to claim 1, wherein the drive for the mutually laterally adjusting the cutting edges with respect to each other is adapted for adjusting the cutting edges with respect to each other both during a cutting stroke and during a returning stroke.

20. Cutting device according to claim 1, wherein the cutting edges are each situated substantially in one plane.

21. Cutting device according to claim 20, wherein one of the first and second elements form a lower blade and the other element a lower blade or lower beam.

22. Cutting device according to claim 20, wherein the cutting device is adapted for in operation having the first and second element perform a scissoring motion with respect to each other to realise a cutting motion, wherein the lateral drive comprises a first actuator which engages onto a first end of the first or second element and a second actuator which engages onto an opposite second end of the first or second element.

23. Cutting device according to claim 22, wherein the first and second actuator both engage onto the first or the second element.

24. Cutting device according to claim 22, wherein the drive is adapted to have the first and second actuator exert a mutually different lateral displacement component, preferably during cutting, so that the elements carry out a swivelling motion with respect to each other during cutting.

25. Cutting device according to claim 22, wherein the drive is adapted for having the first and second exert a different force during the cutting motion, preferably a force that changes during cutting.

26. Cutting device for cutting strips from a web of material, particularly a web of unvulcanised rubber, more particularly cord reinforced unvulcanised rubber, comprising a first cutting element and a second cutting element for in cooperation cutting the strips, and a drive for during the movement past each other of the cutting edges adjusting the lateral force of the cutting edges with respect to each other, preferably both during a cutting motion and during a free motion.

27. Cutting device according to claim 26, wherein the first cutting element comprises a first cutting edge and the second cutting element comprises a second cutting edge, and the first and second cutting edge are movable past each other for in cooperation cutting the strips.

28. Cutting device for cutting strips from a web of material, particularly a web of unvulcanised rubber, more particularly cord reinforced unvulcanised rubber, comprising a first cutting element and a second cutting element for in cooperation cutting the strips, sensors for detecting the lateral force the cutting elements exert on each other, and a drive, operationally connected to the sensors, for according to pre-set values adjusting the force the cutting elements exert on each other in lateral direction.

29. Cutting device according to claim 28, wherein the first cutting element comprises a first cutting edge and the second cutting element comprises a second cutting edge, and the first and second cutting edge are movable past each other for in cooperation cutting the strips.

30. Method for cutting strips from a web of material, particularly a web of unvulcanised rubber, more particularly cord reinforced unvulcanised rubber, by means of a cutting device provided with a lower blade and an upper blade, wherein the lower blade and the upper blade during cutting are brought into a mutually negative cutting clearance with respect to each other and at the returning stroke are brought into a mutually positive cutting clearance.

31. Cutting device comprising a first cutting member extending in a longitudinal direction, a second cutting member extending substantially parallel to the first cutting member, which cutting members are moveable past each other substantially along a cutting plane, a first actuator at a first end of a cutting member for exerting an adjustable force during cutting, having a component transverse to the cutting plane and a second actuator at a second end of a cutting member opposite the first end for exerting an adjustable force during cutting having a component transverse to the cutting plane.

32. Cutting device according to claim 31, further comprising a control device for controlling the force of the first and second actuator.

33. Cutting device according to claim 32, wherein the control device is adapted for adjusting the force exerted by the first actuator and the force exerted by the second actuator independent from each other.

34. Cutting device according to claim 32, further provided with a measuring device for reading the force during cutting which is operationally connected to the control device.

35. Cutting device according to claim 34, wherein the control device is adapted for comparing a force as determined by the measuring device and a pre-set force, and on the basis of the comparison adjusting the force exerted by the first and/or second actuator, preferably the control device is adapted for during cutting comparing a force as determined by the measuring device and a set force and adjusting the force exerted by the first and/or second actuator.

36. Control device intended and suitable for a cutting device according to claim 32.

37. Computer software comprising software instructions which, once operative in a computer device, will let it function as control device according to claim 32.

38. Cutting device for cutting strips from a web of unvulcanised rubber, more particularly cord reinforced unvulcanised rubber, comprising a first element having a first cutting edge, a second element having a second cutting edge, wherein the first and second cutting edge are movable past each other substantially in a cutting plane for in cooperation cutting the strips, and a drive which engages onto at least one of either the first or the second element for during cutting moving the cutting edges with respect to each other out of the cutting plane.

39. Cutting device according to claim 38, wherein the drive is adapted for dynamically moving the elements.

40. Cutting device for cutting unvulcanised rubber, preferably unvulcanised rubber provided with cord reinforcement, comprising a first element having a first cutting edge, a second element having a second cutting edge, wherein the first and second cutting edge are movable past each other substantially in a cutting plane for cutting in cooperation, and a drive for during cutting dynamically deforming at least one cutting edge.

41-43. (canceled)
